(19) United States
(12) Patent Application Publication
(10) Pub. No.: US 2022/0207357 A1
(43) Pub. Date: Jun. 30, 2022

(54) METHOD OF SHORT-TERM LOAD FORECASTING VIA ACTIVE DEEP MULTI-TASK LEARNING, AND AN APPARATUS FOR THE SAME

(71) Applicant: SAMSUNG ELECTRONICS CO., LTD., Suwon-si (KR)

(72) Inventors: Di WU, Montreal (CA); Michael JENKIN, Toronto (CA); Xue LIU, Montreal (CA); Gregory Lewis DUDEK, Montreal (CA)

(73) Assignee: SAMSUNG ELECTRONICS CO., LTD., Suwon-si (KR)

(21) Appl. No.: 17/359,919

(22) Filed: Jun. 28, 2021

Related U.S. Application Data
(60) Provisional application No. 63/133,078, filed on Dec. 31, 2020.

(51) Int. Cl. G06N 3/08; G06N 3/04

(52) U.S. Cl. CPC G06N 3/08; G06N 3/0454

(57) ABSTRACT

A method of load forecasting using multi-task deep learning includes obtaining references data corresponding to commodity consuming objects, clustering the commodity consuming objects into clusters based on the obtained reference commodity consumption data; obtaining cluster models based on: reference commodity consumption data, reference environmental data, and reference calendar data; inputting, into the cluster models, present data corresponding to the commodity consuming objects; and predicting, based on an output of the cluster models, a future commodity consumption for the commodity consuming objects. The cluster models include multi-task learning processes having joint loss functions.

### CROSS-REFERENCE TO RELATED APPLICATION(S)

This application is based on and claims priority under 35 U.S.C. § 119 to U.S. Provisional Patent Application No. 63/133,078, filed on Dec. 31, 2020, in the U.S. Patent & Trademark Office, the disclosure of which is incorporated by reference herein in its entirety.

### BACKGROUND

### 1. Field

The disclosure relates to a method of load forecasting, and an apparatus for the same, and more particularly to a method of short-term load forecasting via active deep multitask learning, and an apparatus for the same.

### 2. Description of Related Art

Electric load forecasting is essential for the secure and economic operation of the power grid. Depending on the forecasting horizon, electric load forecasting ranges from short-term (hours or minutes ahead) to long-term (years ahead). Short-Term electricity Load Forecasting (STLF) is mainly used to assist real-time energy dispatching while long-term load forecasting is mainly applied for power grid infrastructure planning. Accurate short-term electric load forecasting can facilitate efficient residential energy management and power grid operation. As electricity is hard to store in large quantities and considering the safety requirements of power systems, it is of critical importance to keep the power generation as close to the actual power demand as possible. There is also a significant financial incentive for accurate power demand estimation. It is estimated that even a 1% forecasting error increase could lead to more than £10 million increase for the operation cost of the UK power grid.

The modem power grid is facing fundamental changes and, as a result, is evolving into a more and more sustainable system. The use of renewable energy generation, including wind and solar power generation, has increased exponentially over the last 10 years. The output level of renewable energy sources can be quite intermittent and is highly influenced by weather conditions. Besides uncertainties in power generation, there are increasing uncertainties on the demand side caused by electric vehicles (EVs) and the use of other high-demand electric appliances. The adoption of EVs has been growing very fast over the last few years. The annual sale of EVs increased by 79% in Canada and 81% in the US in 2018. EV charging demand is highly affected by the driving behaviors of individuals. Due to these factors, accurate short-term residential load forecasting is becoming more and more challenging.

### SUMMARY

According to an aspect of the disclosure, a method of load forecasting using multi-task deep learning may include inputting, into a first cluster model, present environmental data and present calendar data corresponding to first commodity consuming objects of a first cluster, among a plurality of commodity consuming objects corresponding to a plurality of clusters; and predicting, based on an output of the first cluster model, a future commodity consumption for each of the first commodity consuming objects of the first cluster. The first cluster model may be trained based on first reference commodity consumption data, first reference environmental data, and first reference calendar data, with regard to the first cluster corresponding to the first commodity consuming objects. The plurality of commodity consuming objects may be clustered into the plurality of clusters based on reference commodity consumption data, reference environmental data, and reference calendar data that are obtained over a period of time. The first cluster model may include a first multi-task learning process having a first joint loss function, and each input of the first multi-task learning process may correspond to a respective commodity consuming object of the first cluster.

According to another aspect of the disclosure, an apparatus for forecasting load using multi-task deep learning may include at least one memory storing instructions; and at least one processor configured to execute the instructions to: input, into a first cluster model, present environmental data and present calendar data corresponding to first commodity consuming objects of a first cluster, among a plurality of commodity consuming objects corresponding to a plurality of clusters; and predict, based on an output of the first cluster model, a future commodity consumption for each of the first commodity consuming objects of the first cluster. The first cluster model may be trained based on first reference commodity consumption data, first reference environmental data, and first reference calendar data, with regard to the first cluster corresponding to the first commodity consuming objects. The plurality of commodity consuming objects may be clustered into the plurality of clusters based on reference commodity consumption data, reference environmental data, and reference calendar data that are obtained over a period of time. The first cluster model may include a first multi-task learning process having a first joint loss function, and each input of the first multi-task learning process may correspond to a respective commodity consuming object of the first cluster.

According to another aspect of the disclosure, a non-transitory computer-readable medium may store instructions including one or more instructions that, when executed by one or more processors, cause the one or more processors to: input, into a first cluster model, present environmental data and present calendar data corresponding to first commodity consuming objects of a first cluster, among a plurality of commodity consuming objects corresponding to a plurality of clusters; and predict, based on an output of the first cluster model, a future commodity consumption for each of the first commodity consuming objects of the first cluster. The first cluster model may be trained based on first reference commodity consumption data, first reference environmental data, and first reference calendar data, with regard to the first cluster corresponding to the first commodity consuming objects. The plurality of commodity consuming objects may be clustered into the plurality of clusters based on reference commodity consumption data, reference environmental data, and reference calendar data that are obtained over a period of time. The first cluster model may include a first multi-task learning process having a first joint loss function, and each input of the first multi-task learning process may correspond to a respective commodity consuming object of the first cluster.

According to another aspect of the disclosure, a method of load forecasting using multi-task deep learning may include obtaining reference commodity consumption data, reference environmental data, and reference calendar data for a plurality of commodity consuming objects over a period of time; clustering the plurality of commodity consuming objects into a plurality of clusters based on the obtained reference commodity consumption data, the plurality of clusters comprising a first cluster and a second cluster; obtaining a first cluster model based on: first reference commodity consumption data, among the obtained reference commodity consumption data, corresponding to first commodity consuming objects of the first cluster; first reference environmental data, among the obtained reference environmental data, corresponding to the first commodity consuming objects of the first cluster; and first reference calendar data, among the obtained reference calendar data, corresponding to the first commodity consuming objects of the first cluster; inputting, into the first cluster model, present environmental data and present calendar data corresponding to the first commodity consuming objects of the first cluster; and predicting, based on an output of the first cluster model, a future commodity consumption for each of the first commodity consuming objects of the first cluster. The first cluster model may include a first multi-task learning process having a first joint loss function, and each input of the first multi-task learning process may correspond to a respective commodity consuming object of the first cluster.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of a method for aggregate load forecasting according to an embodiment;

FIG. 2A is a diagram of a clustering operation of the method for aggregate load forecasting according to an embodiment;

FIG. 2B is a diagram of a cluster specific training operation of the method for aggregate load forecasting according to an embodiment;

FIG. 2C is a diagram of a prediction operation of the method for aggregate load forecasting according to an embodiment;

FIG. 2D is a diagram of an aggregating operation according to an embodiment;

FIG. 3 is a diagram of an Long Short-Term Memory based multi-task learning model for aggregate load forecasting according to an embodiment;

FIG. 4 is a diagram of an Long Short-Term Memory based multi-task learning model for single commodity consuming object load forecasting according to an embodiment;

FIG. 5 diagram of an electronic device for performing the forecasting method according to an embodiment;

FIG. 6 is a diagram of a network environment for performing the forecasting method according to an embodiment;

FIG. 7 is a flowchart of a method 700 of aggregate load forecasting according to an embodiment;

FIG. 8 is a flowchart of a method 800 of single-object load forecasting according to an embodiment according to an embodiment;

FIG. 9 is a flowchart of a clustering process 900 for homes according to an embodiment;

FIG. 10 is a diagram of a process 1000 of creating a cluster model according to an embodiment;

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

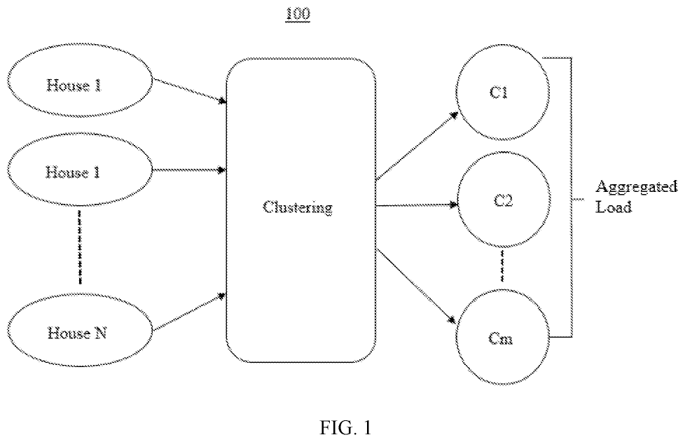

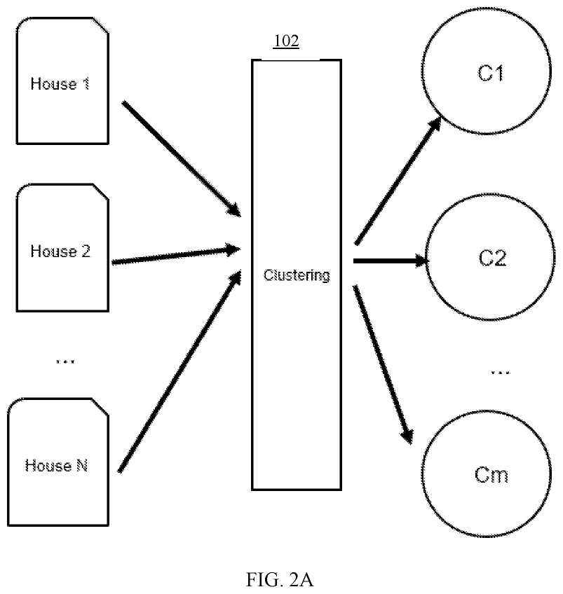

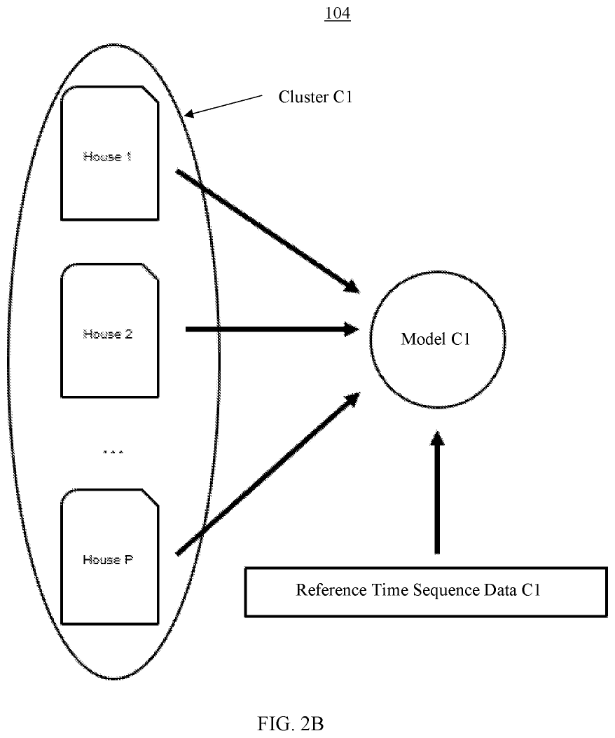

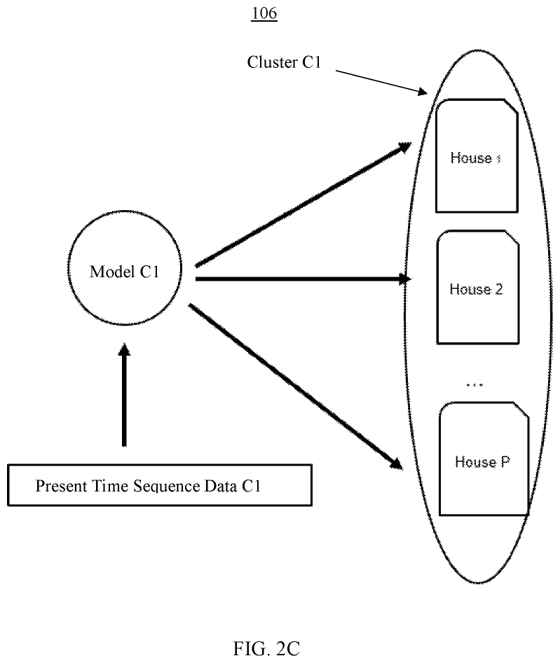

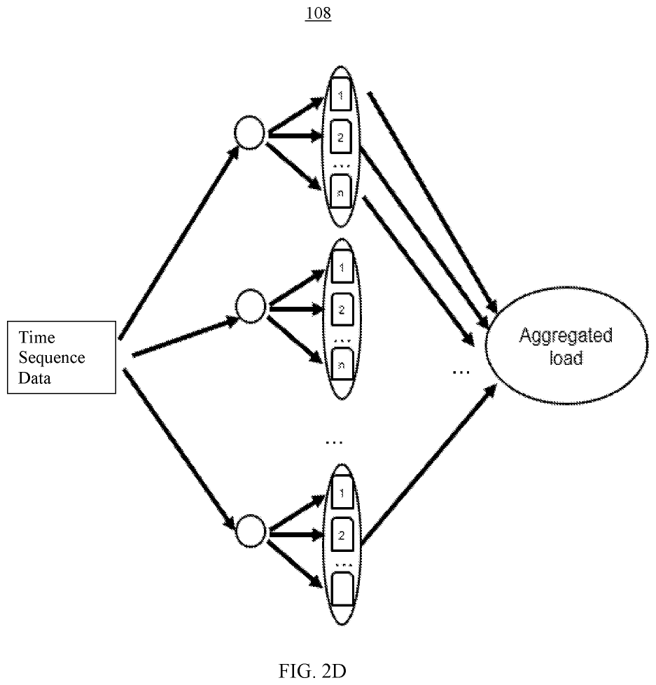

FIG. 1 is a diagram showing a general overview of a method 100 for aggregate load forecasting according to an embodiment. FIGS. 2A-2D are diagrams showing different steps of the method 100. The method 100 may be used to forecast any type of load having corresponding information that can be used to predict a future load, and is not limited to the specific example embodiments discussed herein. For example, the method 100 can be used to predict electric loads, communication system traffic loads, transportation traffic loads, and the like. For the sake of explanation, the following description of method 100 will discuss an embodiment that predicts residential electricity loads for a plurality of houses.

As shown in FIG. 1, the method 100 forecasts electric load for house 1 through house N. The method 100 groups the houses 1-N into cluster C1 through cluster Cm. A forecasting model is then created for each of the clusters C1-Cm and, the forecasting models are used to generate an electric load forecast for the houses in a corresponding cluster. The forecasts are then combined into a final aggregated electric load forecast for the group of houses 1-N by combining the aggregate load of the clusters C1-Cm.

FIG. 2A shows a clustering operation 102 of method 100. The houses 1-N may be clustered based on their historical electric load consumption. Before clustering the houses 1-N, the historical electric load consumption data may be normalized. Once the historical electric load consumption data is normalized, the clustering process may be performed by clustering the houses 1-N using a K-means method. According to some embodiments, the clustering may be performed using other clustering methods known in the art.

Once the clustering is complete, the houses 1-N are grouped into clusters C1-Cm.

FIG. 2B shows a cluster specific training operation 104 of method 100 that trains a forecasting model (Model C1) specific to the cluster (Cluster C1) using cluster specific reference data (Reference Time Sequence Data A) that is specific to each house in the cluster. The forecasting model may be a Long Short-Term Memory (LSTM) based multi-task learning (MTL) model (hereinafter “MTL-LSTM model”). An embodiment of an MTL-LSTM forecasting model is shown in FIG. 2B. The process shown in FIG. 2B may be performed for each cluster C1-Cm to obtain a model for each cluster C1-Cm.

The cluster specific forecasting model may be trained using historical time sequence data corresponding to house 1 through house P (houses within the cluster). For example, the historical time sequence data (reference data) may include electric load consumption data, temperature data, weather data, and the day of the week (e.g. weekday or weekend) corresponding to the houses 1-N. The reference data is not limited to the above examples, and may include other type of data that may be indicative of future electric load.

FIG. 2C shows a prediction operation 106 of method 100 for predicting the future load of each of houses 1-P in the cluster corresponding to the model. Operation 106 may be performed for each of clusters C1-Cm to predict a future load for each cluster.

As shown in FIG. 2C house specific, present time sequence data corresponding to the houses 1-P in the cluster (Present Time Sequence Data C1) may be fed into the cluster specific forecasting model (Model C1). For example, present load consumption data (e.g. lagged load consumption data for the previous three hours and the current hour), present temperature data (e.g. lagged temperature data for the previous three hours and the current hour) day, and present weather data corresponding to each house 1-P may be input into the model C1 which then outputs predictions for each of the houses. The categories of the present time sequence data may correspond to the categories of the historical time sequence data. Here we number of P houses assigned to cluster C1 1-P for convenience.

FIG. 2D shows aggregate load forecasting operation 108 of method 100. Once the electric load for each house in a cluster is determined in operation 106, an aggregate load for each cluster is determined. An aggregate load for all of houses 1-N may then be determined by combining the aggregated loads for each cluster C1-cm. The aggregate load for each cluster may be determined by combining the forecasted loads of each house in the cluster using a fully connected Neural Network (NN) layer that inputs the forecast data from each home in the respective cluster. The aggregate load for the total of all houses 1-N may be determined by combining the aggregated forecast for each cluster C1-Cm by using a fully connected NN output layer that inputs the forecast data for each cluster C1-Cm.

By clustering the commodity consuming objects (houses) and forecasting the electric loads of the houses based on cluster specific MTL-LSTM models, the accuracy of the forecast may be increased.

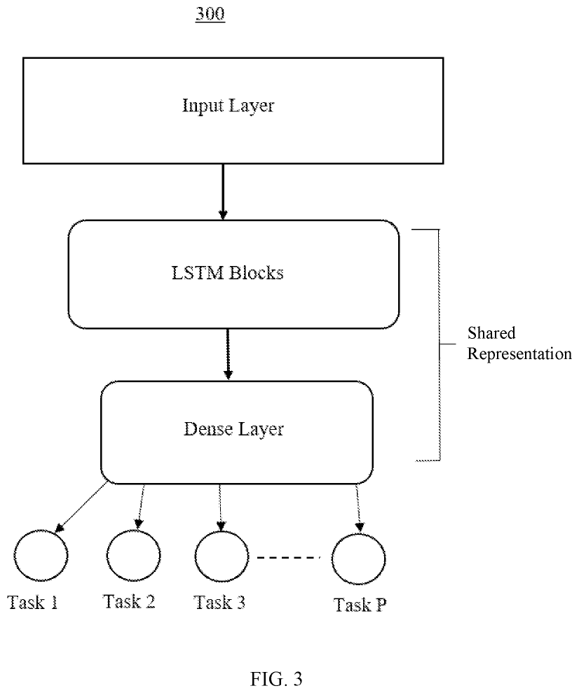

FIG. 3 is a diagram of an MTL-LSTM model 300 for aggregate load forecasting according to an embodiment. As shown in FIG. 3, the MTL-LSTM model may include an input layer, an LSTM block that may include multiple LSTM layers, a dense layer, and an output layer including the output of different tasks. For example, the tasks may correspond to the houses 1-P within a cluster that corresponds to the model. The LSTM block and the dense layer may be shared across learning tasks. When aggregate load forecasting, each task may be treated with equal importance.

To perform short-term load forecasting for the houses in the cluster corresponding to a forecasting model, predictive information may be input into the input layer of the MTL-LSTM model. For example, present electric load consumption data, present temperature data, present weather data, present time, and the present day of the week may be input into the input layer.

The input data may then be fed into the LSTM blocks. Depending on the nature of the data, the LSTM blocks may be composed of different numbers of LSTM layers.

The output of the LSTM blocks may then be fed into a fully connected NN output layer. Multi-task learning may be provided by jointly predicting multiple outputs, with each of the outputs of the output layer corresponding to one of the single learning tasks. Depending on details of the forecasting tasks, there may be different inputs and outputs.

According to an embodiment, a method may be used to forecast a load for a single commodity consuming object, as opposed to the aggregate load forecasting of method 100. For example, in single house load forecasting, each house 1-N in a group may be clustered similar to the clustering performed by method 100. However, the cluster specific forecasting model for single home load forecasting may be different than the cluster specific forecasting model for aggregate load forecasting.

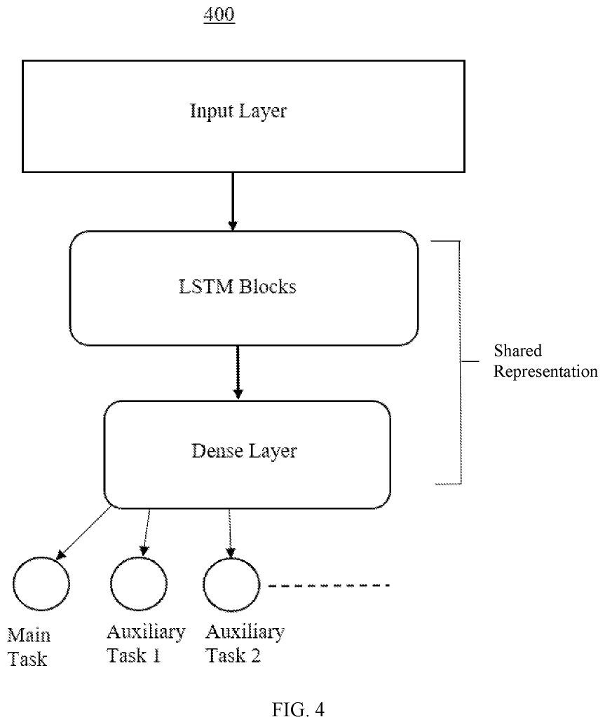

FIG. 4 is a diagram of an MTL-LSTM model 400 for single commodity consuming object load forecasting according to an embodiment. As shown in FIG. 4, the MTL-LSTM model may include an input layer, an LSTM block that may include multiple LSTM layers, a dense layer, and an output layer including the output of different tasks. For example, the tasks may correspond to houses 1-P in the cluster corresponds to the model 400. The LSTM block and the dense layer may be shared across learning tasks.

As shown in FIG. 4, for single home load forecasting, a main task may be assigned to a target home in which the load is being forecasted and auxiliary tasks are assigned to the other homes in the cluster that are not being forecast. That is, the task related to the house in which the load is being forecast (main task) may be treated as the main learning objecting and the other tasks (auxiliary tasks) may be used to assist in the learning of the main task.

In the method for forecasting a load for a single commodity consuming object, the forecast may not consider information for clusters other than the cluster including the single house being forecast. That is, the forecasting model 400 may be trained based on historical time sequence data from only houses of the cluster including the target house being forecast, may input current time sequence data from only houses of the cluster including the target house, and may determine the load forecast for the target house based on only the output of the model 400.

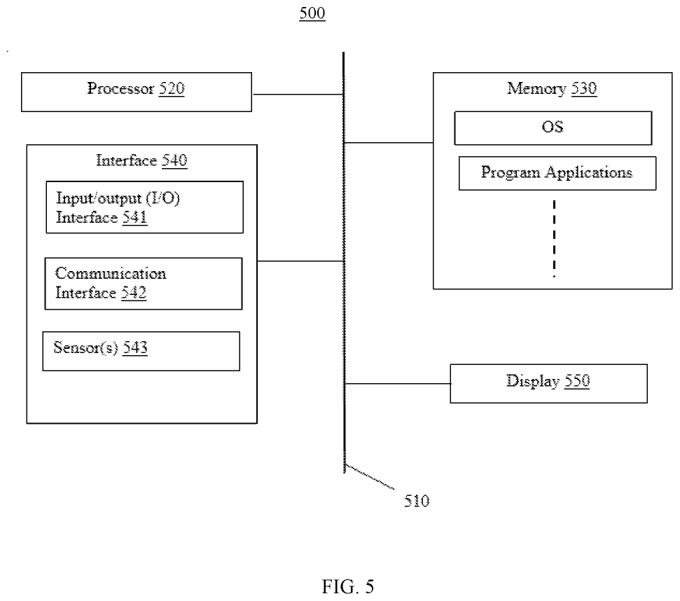

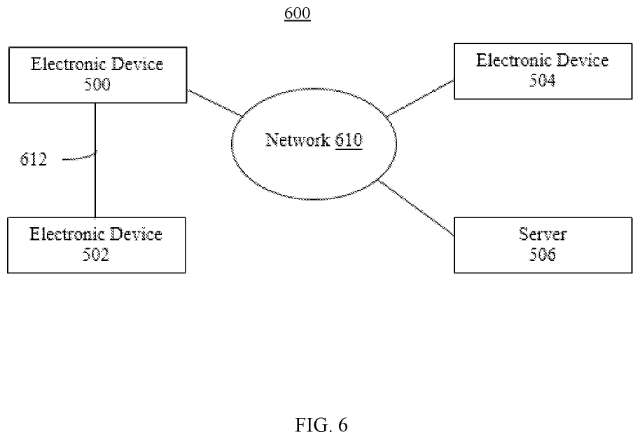

The forecasting method may be performed by electronic device 500 of FIG. 5, in a network environment 600 as shown in FIG. 6, according to an embodiment. FIGS. 5 and 6 are for illustration only, and other embodiments of the electronic device and network could be used without departing from the scope of this disclosure.

As shown in FIG. 5 electronic device 500 includes at least one of a bus 510, a processor 520 (or a plurality of processors), a memory 530, an interface 540, or a display 550.

Bus 510 may include a circuit for connecting the components 520, 530, 540, and 550 with one another. Bus 510 may function as a communication system for transferring data between the components, or between electronic devices.

Processor 520 may include one or more of a central processing unit (CPU), a graphics processor unit (GPU), an accelerated processing unit (APU), many integrated core (MIC), a field-programmable gate array (FPGA), or a digital signal processing (DSP). Processor 520 may control at least one of other components of electronic device 500, and/or perform an operation or data processing relating to communication. Processor 520 may execute one or more programs stored in memory 530.

Memory 530 may include a volatile and/or a non-volatile memory. Memory 530 may store information, such as one or more commands, data, programs (one or more instructions), or applications, etc., that is related to at least one other component of the electronic device 500 and for driving and controlling electronic device 500. For example, commands or data may formulate an operating system (OS). Information stored in memory 530 may be executed by processor 520.

The application may include one or more embodiments as discussed above. These functions can be performed by a single application or by multiple applications that each carry out one or more of these functions.

Display 550 may include, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. Display 550 can also be a depth-aware display, such as a multi-focal display. Display 550 is able to present, for example, various contents (such as text, images, videos, icons, or symbols).

Interface 540 may include input/output (I/O) interface 541, communication interface 542, and/or one or more sensors 543. I/O interface 541 serves as an interface that can, for example, transfer commands or data between a user or other external devices and other component(s) of electronic device 500.

Sensor(s) 543 may meter a physical quantity or detect an activation state of electronic device 500 and may convert metered or detected information into an electrical signal. For example, sensor(s) 543 may include one or more cameras or other imaging sensors for capturing images of scenes. The sensor(s) 543 may also include a microphone, a keyboard, a mouse, one or more buttons for touch input, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (EGG) sensor, an infrared (IR) sensor, an ultrasound sensor, an iris sensor, or a fingerprint sensor. The sensor(s) 543 can further include an inertial measurement unit. In addition, sensor(s) 543 can include a control circuit for controlling at least one of the sensors included here. Any of these sensor(s) 543 can be located within or coupled to electronic device 500. Sensor(s) 543 may be used to detect touch input, gesture input, hovering input using an electronic pen or a body portion of a user, etc.

Communication interface 542, for example, may be able to set up communication between electronic device 500 and an external electronic device (such as a first electronic device 502, a second electronic device 504, or a server 506 as shown in FIG. 6). As shown in FIG. 6, communication interface 542 may be connected with a network 610 and/or 612 through wireless or wired communication architecture to communicate with an external electronic device. Communication interface 142 may be a wired or wireless transceiver or any other component for transmitting and receiving signals.

FIG. 6 shows an example network configuration 600 according to an embodiment. Electronic device 500 of FIG. 5 may be connected with a first external electronic device 502, a second external electronic device 504, or a server 506 through network 610 and/or 612. Electronic device 500 may be wearable device, an electronic device-mountable wearable device (such as an FIMD), etc. When electronic device 500 is mounted in the electronic device 502 (such as the FIMD), electronic device 500 may communicate with electronic device 502 through communication interface 542. Electronic device 500 may be directly connected with electronic device 502 to communicate with electronic device 502 without involving a separate network. Electronic device 500 may also be an augmented reality wearable device, such as eyeglasses, that include one or more cameras.

The first and second external electronic devices 502 and 504 and server 506 may each be a device of a same or a different type than electronic device 500. According to some embodiments, server 506 may include a group of one or more servers. Also, according to some embodiments, all or some of the operations executed on electronic device 500 may be executed on another or multiple other electronic devices (such as electronic devices 502 and 504 or server 506). Further, according to some embodiments, when electronic device 500 should perform some function or service automatically or at a request, electronic device 500, instead of executing the function or service on its own or additionally, can request another device (such as electronic devices 502 and 504 or server 506) to perform at least some functions associated therewith. The other electronic device (such as electronic devices 502 and 504 or server 506) may be able to execute the requested functions or additional functions and transfer a result of the execution to electronic device 500. Electronic device 500 can provide a requested function or service by processing the received result as it is or additionally. To that end, a cloud computing, distributed computing, or client-server computing technique may be used, for example. While FIGS. 5 and 6 show that electronic device 500 including communication interface 542 to communicate with external electronic devices 502 and 504 or server 506 via the network 610 or 612, electronic device 500 may be independently operated without a separate communication function according to some embodiments.

Server 506 may include the same or similar components 510, 520, 530, 540, and 550 as electronic device 500 (or a suitable subset thereof). Server 506 may support driving electronic device 500 by performing at least one of operations (or functions) implemented on electronic device 500. For example, server 506 can include a processing module or processor that may support processor 520 of electronic device 500.

The wireless communication may be able to use at least one of, for example, long term evolution (LTE), long term evolution-advanced (LTE-A), 5th generation wireless system (5G), millimeter-wave or 60 GFIz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection may include, for example, at least one of a universal serial bus (USB), high definition multimedia interface (HDMI), recommended standard 232 (RS-232), or plain old telephone service (POTS). The network 610 or 612 includes at least one communication network, such as a computer network (like a local area network (LAN) or wide area network (WAN)), Internet, or a telephone network.

Although FIG. 6 shows one example of a network configuration 600 including an electronic device 500, two external electronic devices 502 and 504, and a server 506, various changes may be made to FIG. 6. For example, the network configuration 500 could include any number of each component in any suitable arrangement. In general, computing and communication systems come in a wide variety of configurations, and FIG. 5 does not limit the scope of this disclosure to any particular configuration. Also, while FIG. 5 shows one operational environment in which various features disclosed in this patent document can be used, these features could be used in any other suitable system.

The forecasting method may be written as computer-executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 100, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The forecasting method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of server 106.

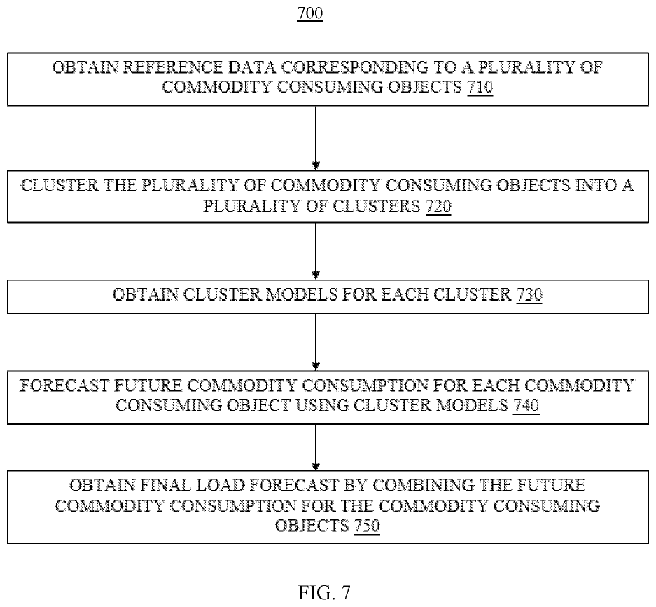

FIG. 7 is a flowchart of a method 700 of aggregate load forecasting according to an embodiment. The method 700 may be used to forecast any type of predictable load such as an electric load, communication system traffic load, transportation traffic load, or any type of process that consumes a commodity. A commodity may be any type of asset that may be consumed. For example, in electric load forecasting, the commodity is electricity. In communication system traffic forecasting, the commodity may be an amount of bandwidth needed to transfer the communication data.

In operation 710, reference time series commodity consumption data and corresponding support data corresponding to a plurality of commodity consuming objects may be obtained (i.e. reference data is obtained). For example, for electric load forecasting, historical electric load data for each of a plurality of houses (consumption data) may be acquired over a past month along with temperature, weather, time, and day of the week data (support data) that is acquired in conjunction with the electric load data over the past month.

In an embodiment that forecasts communication system traffic, traffic load data (consumption data) acquired during a past year may be obtained along with time, day of the week, day of the month, and day of the year data (support data) that corresponds to the acquired historical traffic load data.

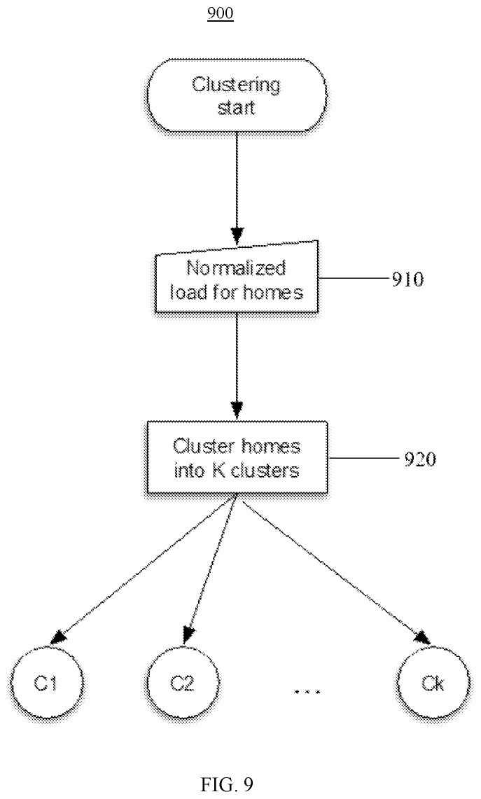

In operation 720, the plurality of commodity consuming objects may be clustered into clusters based on their historical consumption data. FIG. 9 is a flowchart of a clustering process 900 for homes according to an embodiment.

As shown in FIG. 9, at operation 910 the loads for each commodity consuming object may be normalized. At operation 920, the commodity consuming objects may be clustered into K amount of clusters based on the normalized data. According to an embodiment, the commodity consuming objects may be clustered using a K-means method. According to other embodiments, other clustering methods known in the art may be used, such as means-shift clustering, density based spatial clustering, expectation-maximum clustering, and agglomerative hierarchical clustering.

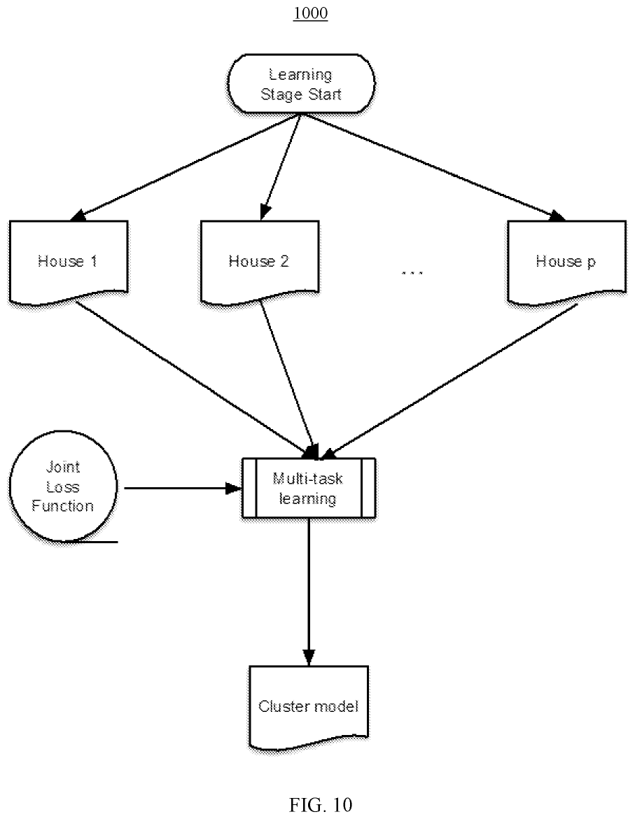

In operation 730, cluster models may be obtained for each cluster. According to an embodiment, obtaining a cluster model may include training an MTL-LSTM forecasting model with reference data (e.g. consumption data and corresponding support data). FIG. 10 shows an embodiment of a process 1000 of creating a cluster model.

As shown in FIG. 10, reference data for each house in the cluster (house 1 through house p) are input into a multitask learning model designed to optimize a joint loss function. According to an embodiment, the joint loss function may be defined by the following Equation 1.

[symbol]

_{MTL}= [symbol] ( [symbol] ¹(ŷᵢ,yᵢ), . . . , [symbol] ^{k}(ŷᵢ,yᵢ)) [1]

In Equation 1, [symbol] ^{k}(yᵢ, y₁) is the individual loss function for the k′th task. Each individual loss function may correspond to a commodity consuming object in the cluster corresponding to the cluster model. According to an embodiment, for aggregate load forecasting, all of the individual learning tasks may be treated equally.

In operation 740, future commodity consumption for each commodity consuming object may be forecasted by inputting present data into the obtained cluster models. As such, the future commodity consumption may be determined for each cluster using a corresponding cluster model. That is, each cluster model may input present data corresponding to the commodity consuming objects in the cluster corresponding to the model and output a commodity consumption forecast for each object in the cluster.

For example, when forecasting electric loads of houses, each cluster of houses may be forecasted independently using their respective cluster model. For each cluster, consumption data of each house in the cluster for the previous three hours and the current hour, temperature data from each house for the previous three hours and the current hour, and the day of the week (e.g. weekday versus weekend) may be input into their trained cluster model to predict the future electricity consumption (e.g. next hour) for each house in the cluster.

In operation 750, a final load forecast may be obtained by combining the forecasted future commodity consumption for each of the clusters. Per-cluster forecasts may be obtained using a fully connected neural network layer which inputs each forecast for the cluster. The per-cluster forecasts may then be combined using a fully connected neural network output layer to form a final forecast of the aggregated electric load for each of the houses being forecasted.

Algorithm 1 below shows an embodiment of an aggregate load forecasting algorithm that is consistent with method 800.

Algorithm 1 ADMR: Active Deep Multi-
task learning based Regression

Input: Historical data sets for N homes, [symbol] ₁, . . . , [symbol] _{N}, number of
clusters K

| | |
|---|---|
| 1: | Clustering Stage |
| 2: | Obtain the normalized load for all the homes |
| 3: | Cluster the homes into K cluster using the K means method |
| 4: | multi-task Learning Stage |
| 5: | for c = 1, ..., K do |
| 6: | Implement multi-task learning for cluster c by optimizing the |
| | joint, loss [symbol] _{MTL} (Equation 1) |
| 7: | end for |
| 8: | Aggregation Stage (Forecasting Stage) |
| 9: | for c = 1, ..., K do |
| 10: | Forecast the load of each individual home with the learned |
| | MTL model for cluster c |
| 11: | Aggregate the predicted load together |
| 12: | end for |

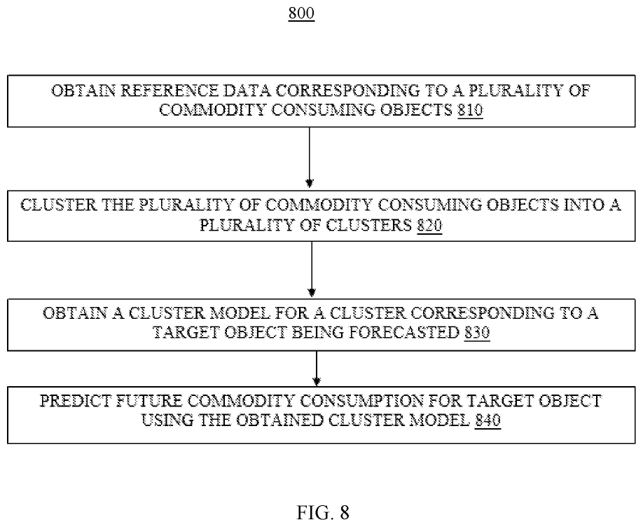

FIG. 8 is a flowchart of a method 800 of single-object load forecasting according to an embodiment. Similar to the method 700, the method 800 may be used to forecast any type of predictable load such as an electric load, communication system traffic load, transportation traffic load, or any type of process that consumes a commodity. Discussion of operations that are similarly performed in method 700 may be omitted in the discussion of method 800 to prevent redundant discussion.

In operation 810, reference time series data may be obtained for each commodity consuming object in a group.

In operation 820, the plurality of commodity consuming objects may be clustered into a plurality of clusters based on historical consumption data.

In operation 830, a cluster model for a cluster including a target commodity consuming object (“target object”) being forecasted may be obtained. According to an embodiment, the cluster model may be an MTL-LSTM forecasting model. The MTL-LSTM model may be designed to optimize a loss function that focuses on improving the forecasting accuracy of the target object. The MTL-LSTM model may include a main task (target object) and auxiliary tasks (objects in the cluster other than the target object).

According to an embodiment, the joint loss function may be defined by the following Equation 2.

$${ℒ}_{MT} ( f ( I , θ ) , Y ) = {λ}_{m} {ℒ}_{m} ( {\hat{y}}^{m} , {y}_{i}^{m} ) + {\sum }_{t = 1}^{T} {λ}_{t} \cdot {ℒ}_{t} ( {\hat{y}}^{t} , {y}^{t} ) \qquad [ 2 ]$$

In Equation 2, [symbol] ₘ shows the loss for the main task (target object), [symbol] ₜ is the loss for the t′th auxiliary task, and λₘ and λₜ are the associated weights. Y=(y^{m}, y¹, y², . . . , y^{T}) is a vector composed by real values of different tasks and I is the input vector for all tasks.

In operation 840, the future commodity consumption for the target object may be forecasted using the MTL-LSTM model obtained in operation 830. As discussed above, the MTL-LSTM model may optimize forecasting accuracy for the target home.

The future commodity consumption for the target object may be forecasted by inputting present data corresponding to the commodity consuming objects of the cluster into the MTL-LSTM model obtained in operation 830. An output of the MTL-LSTM model may then be used in the forecasting future commodity consumption of the target object.

Algorithm 1 above may be adapted to an algorithm (“Algorithm 2”) for the single-object load forecasting. Algorithm 2 may have the same general structure as Algorithm 1, but with the following modifications. In the clustering stage, the target house may be assigned to one of the clusters. The other houses in the same cluster as the target house may be used as auxiliary houses for the target house to assist the target house's load forecasting. In the multi-task learning stage, the multi-task learning may be implemented based on the overall loss which is composed by the loss function defined in Equation 2. The weights for the different tasks may be hyperparmerters and can be determined by checking the validation set's performance.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method of load forecasting using multi-task deep learning, the method comprising:
inputting, into a first cluster model, present environmental data and present calendar data corresponding to first commodity consuming objects of a first cluster, among a plurality of commodity consuming objects corresponding to a plurality of clusters; and
predicting, based on an output of the first cluster model, a future commodity consumption for each of the first commodity consuming objects of the first cluster,
wherein the first cluster model is trained based on first reference commodity consumption data, first reference environmental data, and first reference calendar data, with regard to the first cluster corresponding to the first commodity consuming objects,
wherein the plurality of commodity consuming objects are clustered into the plurality of clusters based on reference commodity consumption data, reference environmental data, and reference calendar data that are obtained over a period of time, and
wherein the first cluster model comprises a first multi-task learning process having a first joint loss function, and each input of the first multi-task learning process corresponds to a respective commodity consuming object of the first cluster.

2. The method of claim 1, wherein the first joint loss function of the first multi-task learning process optimizes a task corresponding to a single commodity consuming object among the first commodity consuming objects of the first cluster.

3. The method of claim 1, further comprising:
inputting, into a second cluster model, present environmental data and present calendar data corresponding to second commodity consuming objects of a second cluster among the plurality of clusters;
predicting, based on an output of the second cluster model, a future commodity consumption for each of the second commodity consuming object of the second cluster; and
obtaining a final forecast based on the predicted future electricity consumption of the first and the second commodity consuming objects of the first and the second clusters,
wherein the second cluster model is trained based on second reference commodity consumption data, second reference environmental data, and second reference calendar data, with regard to the second cluster among the plurality of clusters, and
wherein the second cluster model comprises a second multi-task learning process having a second joint loss function, and each input of the second multi-task learning process corresponds to a respective commodity consuming object of the second cluster.

4. The method of claim 3, wherein the first and the second joint loss functions of the first and the second multi-task learning processes treat all learning tasks with equal importance.

5. The method of claim 3, wherein the obtaining the final forecast comprises combining the predicted future commodity consumption of the electricity consuming objects of the first and the second clusters using a fully connected neural network output layer.

6. The method of claim 3, wherein the present environmental data and present calendar data corresponding to the first commodity consuming objects of the first cluster and the present environmental data and present calendar data corresponding to the second commodity consuming objects of the second cluster comprise time series data sets in which a final time corresponds to a current time.

7. The method of claim 1, wherein the plurality of clusters comprises the first cluster through an Nth cluster,
the method further comprising:
obtaining cluster models for each of the first through the Nth clusters; and
obtaining a final forecast based on predicted future commodity consumption of the commodity consuming objects of the first through the Nth clusters,
wherein the first through Nth cluster models comprise multi-task learning processes having the first joint loss function through an Nth joint loss function, respectively,
wherein the inputs of the multi-task learning processes correspond to commodity consuming objects of corresponding clusters, and
wherein the first through the Nth joint loss functions of the multi-task learning processes treat all learning tasks with equal importance.

8. An apparatus for forecasting load using multi-task deep learning, the apparatus comprising:
at least one memory storing instructions; and
at least one processor configured to execute the instructions to:
input, into a first cluster model, present environmental data and present calendar data corresponding to first commodity consuming objects of a first cluster, among a plurality of commodity consuming objects corresponding to a plurality of clusters; and
predict, based on an output of the first cluster model, a future commodity consumption for each of the first commodity consuming objects of the first cluster,
wherein the first cluster model is trained based on first reference commodity consumption data, first reference environmental data, and first reference calendar data, with regard to the first cluster corresponding to the first commodity consuming objects,
wherein the plurality of commodity consuming objects are clustered into the plurality of clusters based on reference commodity consumption data, reference environmental data, and reference calendar data that are obtained over a period of time, and
wherein the first cluster model comprises a first multi-task learning process having a first joint loss function, and each input of the first multi-task learning process corresponds to a respective commodity consuming object of the first cluster.

9. The apparatus of claim 8, wherein the first joint loss function of the first multi-task learning process optimizes a task corresponding to a single commodity consuming object among the first commodity consuming objects of the first cluster.

10. The apparatus of claim 8, wherein the at least one processor is further configured to:
input, into a second cluster model, present environmental data and present calendar data corresponding to second commodity consuming objects of a second cluster among the plurality of clusters;
predict, based on an output of the second cluster model, a future commodity consumption for each of the second commodity consuming object of the second cluster; and
obtain a final forecast based on the predicted future electricity consumption of the first and the second commodity consuming objects of the first and the second clusters,
wherein the second cluster model is trained based on second reference commodity consumption data, second reference environmental data, and second reference calendar data, with regard to the second cluster among the plurality of clusters, and
wherein the second cluster model comprises a second multi-task learning process having a second joint loss function, and each input of the second multi-task learning process corresponds to a respective commodity consuming object of the second cluster.

11. The apparatus of claim 10, wherein the first and the second joint loss functions of the first and the second multi-task learning processes treat all learning tasks with equal importance.

12. The apparatus of claim 8, wherein the plurality of clusters comprises the first through an Nth cluster,
wherein the at least one processor is further configured to:
obtain cluster models for each of the first through the Nth clusters; and
obtain a final forecast based on predicted future commodity consumption of the commodity consuming objects of the first through the Nth clusters,
wherein the first through Nth cluster models comprise multi-task learning processes having the first joint loss function through an Nth joint loss function, respectively,
wherein the inputs of the multi-task learning processes correspond to commodity consuming objects of corresponding clusters, and
wherein the first through the Nth joint loss functions of the multi-task learning processes treat all learning tasks with equal importance.

13. A non-transitory computer-readable medium storing instructions, the instructions comprising: one or more instructions that, when executed by one or more processors, cause the one or more processors to:
input, into a first cluster model, present environmental data and present calendar data corresponding to first commodity consuming objects of a first cluster, among a plurality of commodity consuming objects corresponding to a plurality of clusters; and
predict, based on an output of the first cluster model, a future commodity consumption for each of the first commodity consuming objects of the first cluster,
wherein the first cluster model is trained based on first reference commodity consumption data, first reference environmental data, and first reference calendar data, with regard to the first cluster corresponding to the first commodity consuming objects,
wherein the plurality of commodity consuming objects are clustered into the plurality of clusters based on reference commodity consumption data, reference environmental data, and reference calendar data that are obtained over a period of time, and
wherein the first cluster model comprises a first multi-task learning process having a first joint loss function, and each input of the first multi-task learning process corresponds to a respective commodity consuming object of the first cluster.

14. The non-transitory computer-readable medium of claim 13, wherein the first joint loss function of the first multi-task learning process optimizes a task corresponding to a single commodity consuming object among the first commodity consuming objects of the first cluster.

15. The non-transitory computer-readable medium of claim 13, wherein the instructions further cause the one or more processors to
input, into a second cluster model, present environmental data and present calendar data corresponding to second commodity consuming objects of a second cluster among the plurality of clusters;
predict, based on an output of the second cluster model, a future commodity consumption for each of the second commodity consuming object of the second cluster; and
obtain a final forecast based on the predicted future electricity consumption of the first and the second commodity consuming objects of the first and the second clusters,
wherein the second cluster model is trained based on second reference commodity consumption data, second reference environmental data, and second reference calendar data, with regard to the second cluster among the plurality of clusters, and
wherein the second cluster model comprises a second multi-task learning process having a second joint loss function, and each input of the second multi-task learning process corresponds to a respective commodity consuming object of the second cluster.

16. The non-transitory computer-readable medium of claim 15, wherein the first and the second joint loss functions of the first and the second multi-task learning processes treat all learning tasks with equal importance.

17. A method of load forecasting using multi-task deep learning, the method comprising:
obtaining reference commodity consumption data, reference environmental data, and reference calendar data for a plurality of commodity consuming objects over a period of time;
clustering the plurality of commodity consuming objects into a plurality of clusters based on the obtained reference commodity consumption data, the plurality of clusters comprising a first cluster and a second cluster;
obtaining a first cluster model based on:
first reference commodity consumption data, among the obtained reference commodity consumption data, corresponding to first commodity consuming objects of the first cluster;
first reference environmental data, among the obtained reference environmental data, corresponding to the first commodity consuming objects of the first cluster; and
first reference calendar data, among the obtained reference calendar data, corresponding to the first commodity consuming objects of the first cluster;
inputting, into the first cluster model, present environmental data and present calendar data corresponding to the first commodity consuming objects of the first cluster; and
predicting, based on an output of the first cluster model, a future commodity consumption for each of the first commodity consuming objects of the first cluster,
wherein the first cluster model comprises a first multi-task learning process having a first joint loss function, and each input of the first multi-task learning process corresponds to a respective commodity consuming object of the first cluster.

18. The method of claim 17, wherein the first joint loss function of the first multi-task learning process optimizes a task corresponding to a single commodity consuming object among the first commodity consuming objects of the first cluster.

19. The method of claim 17, further comprising:
obtaining a second cluster model based on:
second reference commodity consumption data, among the obtained reference commodity consumption data, corresponding to second commodity consuming objects of the second cluster;
second reference environmental data, among the obtained environmental data, corresponding to the second commodity consuming objects of the second cluster; and
second reference calendar data, among the obtained reference calendar data, corresponding to the second commodity consuming objects of the second cluster;
inputting, into the second cluster model, present environmental data and present calendar data corresponding to the second commodity consuming objects of the second cluster;
predicting, based on an output of the second cluster model, a future commodity consumption for each of the second commodity consuming object of the second cluster; and
obtaining a final forecast based on the predicted future electricity consumption of the first and the second commodity consuming objects of the first and the second clusters,
wherein the second cluster model comprises a second multi-task learning process having a second joint loss function, and each input of the second multi-task learning process corresponds to a respective commodity consuming object of the second cluster.

20. The method of claim 19, wherein the first and the second joint loss functions of the first and the second multi-task learning processes treat all learning tasks with equal importance.
